(19) United States
(12) Patent Application Publication
(10) Pub. No.: US 2015/0090008 A1
(43) Pub. Date: Apr. 2, 2015

(54) INFERENTIAL METHOD AND SYSTEM FOR EVAP SYSTEM LEAK DETECTION

(71) Applicant: FORD GLOBAL TECHNOLOGIES, LLC, Dearborn, MI (US)

(72) Inventors: RUSSELL RANDALL PEARCE, ANN ARBOR, MI (US); AED M. DUDAR, CANTON, MI (US); DENNIS SEUNG-MAN YANG, CANTON, MI (US); SCOTT A. BOHR, NOVI, MI (US)

(73) Assignee: FORD GLOBAL TECHNOLOGIES, LLC, Bearborn, MI (US)

(21) Appl. No.: 14/043,810

(22) Filed: Oct. 1, 2013

(51) Int. Cl. G01M 3/04

(52) U.S. Cl. CPC G01M 3/04
USPC 73/40.7

(57) ABSTRACT

A method for detecting leaks in an evaporative emission control system. The method begins by activating a PCM at a selected interval, for a selected period. During the selected period, the PCM monitors system pressure and temperature. The PCM then determines a relationship between changes in system temperature and changes in system pressure, and it identifies a leak based on predetermined criteria related to the relationship. The relationship can be the ideal gas law, which allows the calculation of an expected pressure, based upon differences in temperature. If the actual pressure is considerably below the expected pressure, then one can infer the presence of a leak.

### TECHNICAL FIELD

Embodiments of the present disclosure generally relate to Evaporative Emission Control Systems (EVAP) for automotive vehicles, and, more specifically, to detecting and repairing leaks within EVAP systems.

### BACKGROUND

Gasoline, the fuel for many automotive vehicles, is a volatile liquid subject to potentially rapid evaporation, in response to diurnal variations in the ambient temperature. Thus, the fuel contained in automobile gas tanks presents a major source of potential emission of hydrocarbons into the atmosphere. Such emissions from vehicles are termed ‘evaporative emissions’ and those vapors can be emitted vapors even when the engine is not running

In response to this problem, industry has incorporated evaporative emission control systems (EVAP) into automobiles, to prevent fuel vapor from being discharged into the atmosphere. EVAP systems include a canister (the carbon canister containing adsorbent carbon) that traps fuel vapor. Periodically, a purge cycle feeds the captured vapor to the intake manifold for combustion, thus reducing evaporative emissions.

Hybrid electric vehicles, including plug-in hybrid electric vehicles (HEV's or PHEV's), pose a particular problem for effectively controlling evaporative emissions. Although hybrid vehicles have been proposed and introduced in a number of forms, these designs all provide a combustion engine as backup to an electric motor. Primary power is provided by the electric motor, and careful attention to charging cycles can produce an operating profile in which the engine is only run for short periods. Systems in which the engine is only operated once or twice every few weeks are not uncommon. Purging the carbon canister can only occur when the engine is running, of course, and if the canister is not purged, the carbon pellets can become saturated, after which hydrocarbons will escape to the atmosphere, causing pollution.

EVAP systems are generally sealed to prevent the escape of any hydrocarbons. These systems require periodic leak detection tests to identify potential problems. Different system suppliers have adopted different testing methods, but all conventional testing methods share the characteristic of being aimed at direct detection of leaks. Some methods evacuate the EVAP system and test whether the vacuum level is maintained, while others pressurized the EVAP system and determine whether the pressure level remain steady. The matter what the method, then, system testing reduces to a search for holes in the physical envelope of the EVAP system.

As environmental protection standards grow more stringent, however, the maximum allowable orifice size decreases to the point where existing technology may no longer suffice to identify leaks. At the present time, the art is capable of identifying and classifying leaks as small as 0.020″, but standards now in the draft stage in visage a coming standard of 0.010″ and below. The NIRCOS Tier III standard, promulgated by the California Air Resources Board, for example, requires greatly improved test procedures.

In order to keep up with accelerating “green” initiatives, a need exists for methods capable of identifying and classifying system leaks having very small orifices.

### SUMMARY

One aspect of the present disclosure describes a method for detecting leaks in an evaporative emission control system. The method begins by activating a PCM at a selected interval, for a selected period. During the selected period, the PCM monitors system pressure and temperature. The PCM then determines a relationship between changes in system temperature and changes in system pressure, and it identifies a leak based on predetermined criteria related to the relationship.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a schematic representation of a EVAP system for a PHEV, in accordance with the present disclosure.

FIG. 2 is a flowchart illustrating an inferential method for EVAP system leak detection in vehicles, according to the present disclosure.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes a method for inferring a leak in an EVAP system, rather than identifying a leak directly. In general, the system monitors the pressure and temperature in an EVAP system at intervals over a period of time. Using changes in temperature, one can calculate an expected pressure value, and if the actual pressure value is significantly below that value, then one can infer the presence of a leak.

### Exemplary Embodiments

The following detailed description illustrates aspects of the disclosure and its implementation. This description should not be understood as defining or limiting the scope of the present disclosure, however, such definition or limitation being solely contained in the claims appended hereto. Although the best mode of carrying out the invention has been disclosed, those in the art would recognize that other embodiments for carrying out or practicing the invention are also possible.

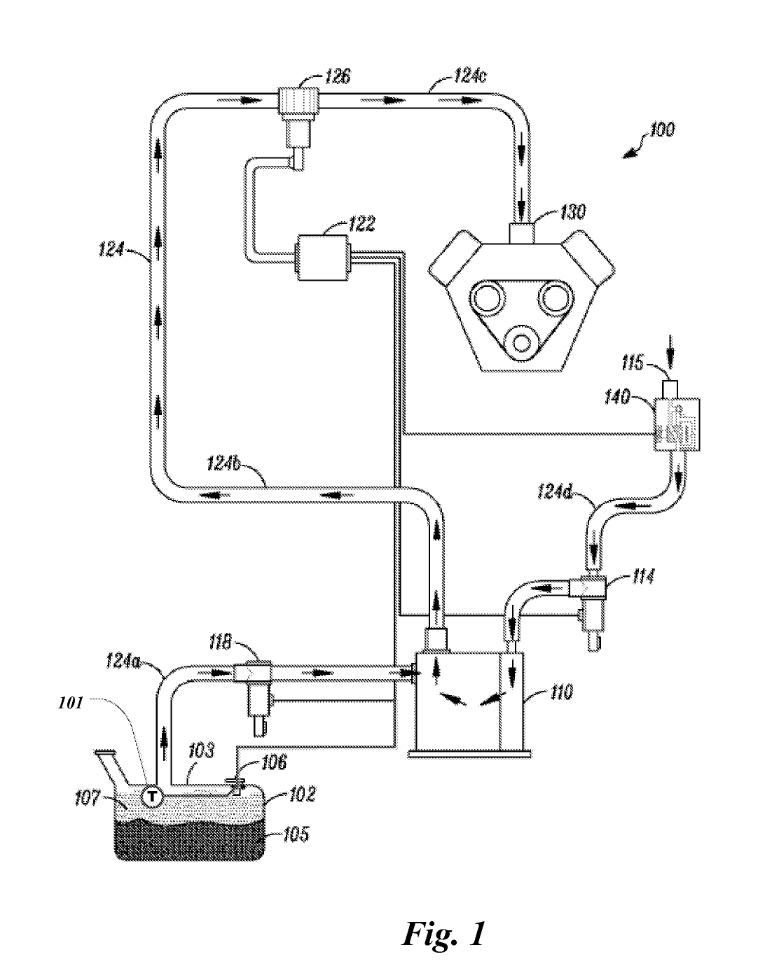

FIG. 1A illustrates an evaporative emissions control system 100. As seen there, the system 100 is made up primarily of the fuel tank 102, a carbon canister 110, and the engine intake manifold 130, all operably connected by lines and valves.105. It will be understood that many variations on this busy design are possible, but the illustrated embodiment follows the general practice of the art. It will be understood that the system 100 is generally sealed, with no open vent to atmosphere.

Fuel tank 102 is partially filled with liquid fuel 105, but a portion of the liquid evaporates over time, producing fuel vapor 107 in the upper portion (or “vapor dome 103”) of the tank. The amount of vapor produced will depend upon a number of environmental variables, such as the ambient temperature. Of these factors, temperature is probably the most important, given the temperature variation produced in the typical diurnal temperature cycle. For vehicles in a sunny climate, particularly a hot, sunny climate, the heat produced by leaving a vehicle standing in direct sunlight can produce very high pressure within the vapor dome 103 of the tank 102. A fuel tank pressure transducer (FTPT) 106 monitors the pressure in the fuel tank vapor dome 103. Additionally, a temperature sensor 101 is also installed within the tank to monitor temperature within vapor dome 103.

Vapor lines 124 operably join various components of the system. One, line 124a, runs from the fuel tank 102 to carbon canister 110. A normally closed fuel tank isolation valve (FTIV) 118 regulates the flow of vapor from fuel tank 102 to the carbon canister 110, so that flows normally freely permitted, so that the carbon pellets can adsorb the vapor generated by evaporating fuel. Vapor line 124b joins line 124a in a T intersection beyond FTIV 118, connecting that line with a normally closed canister purge valve (CPV) 126. Line 124c continues from CPV 126 to the engine intake manifold 130. CPV 126 is controlled by signals from the powertrain control module (PCM) 122, which also controls FTIV 118.

Canister 110 is connected to ambient atmosphere at vent 115, through a normally closed canister vent valve (CPV) 114. Vapor line 124d connects that valve to vent 115 in canister 110. PCM 122 controls CVV 114 as well.

Powertrain Control Module (PCM 122) may include a controller (not shown) of a known type connected to the FTPT 106. Connections may extend to other sensors and devices as well, as shown. The controller may be of a known type, forming one part of the hardware of the automotive control system, and may be a microprocessor-based device that includes a central processing unit (CPU) for processing incoming signals from known sources. The controller may be provided with volatile memory units, such as a RAM and/or ROM that function along with associated input and output buses. Further, the controller may also be optionally configured as an application specific integrated circuit, or may be formed through other logic devices that are well known to the skilled in the art. More particularly, the controller may be formed either as a portion of an existing electronic controller, or may be configured as a stand-alone entity.

During normal operation, FTIV 118, CPV 126, and CVV 114 are all closed. When pressure within vapor dome 103 rises sufficiently, under the influence, for example, of increased ambient temperature, the PCM opens valve 118, allowing vapor to flow to the canister, where carbon pellets can adsorb fuel vapor.

To purge the canister 110, FTIV 118 is closed, and valves 126 and 114 are opened. It should be understood that this operation is only performed when the engine is running, which produces a vacuum at intake manifold 130. That vacuum causes an airflow from ambient atmosphere through vent 115, canister 110, and CPV 126, and then onward into intake manifold 130. As the airflow passes through canister 110, it entrains fuel vapor from the carbon pellets. The fuel vapor mixture then proceeds to the engine, where it is mixed with the primary fuel/air flow to the engine for combustion.

EVAP Leak Check Module (ELCM 140), is typically installed near the vent 115, and is operably connected to the PCM 122. Variations in that arrangement may be envisioned. ELCM 140 can be one of those units widely applied by OEMs to perform EVAP leak checks, such as the ELCM manufactured by Denso Corporation™. Other devices may however be substituted, as known to those in the art.

Conventional leak testing methods directly measure system pressure, starting with a system that has either been pressurized or evacuated, and they determine whether the system is capable of holding that pressure. All such systems are relatively short-term in nature, measuring pressure differentials over tens of minutes, at most. As standards are extended to smaller and smaller maximum orifice sizes, however, those time periods are not sufficient to provide measurable results, at least at reasonable pressure levels.

The present disclosure approaches the leak detection problem with an indirect solution. Here, analysis precedes inferentially, based upon the principles of the ideal gas law, PV=nRT. As is well known, this law relates pressure (P), volume (V), temperature (T), the number of moles (n), and the universal gas constant (R). Using the method set out below, the present disclosure monitors an EVAP system over a period of hours, enabling the detection of leaks well beyond the capabilities of conventional technology.

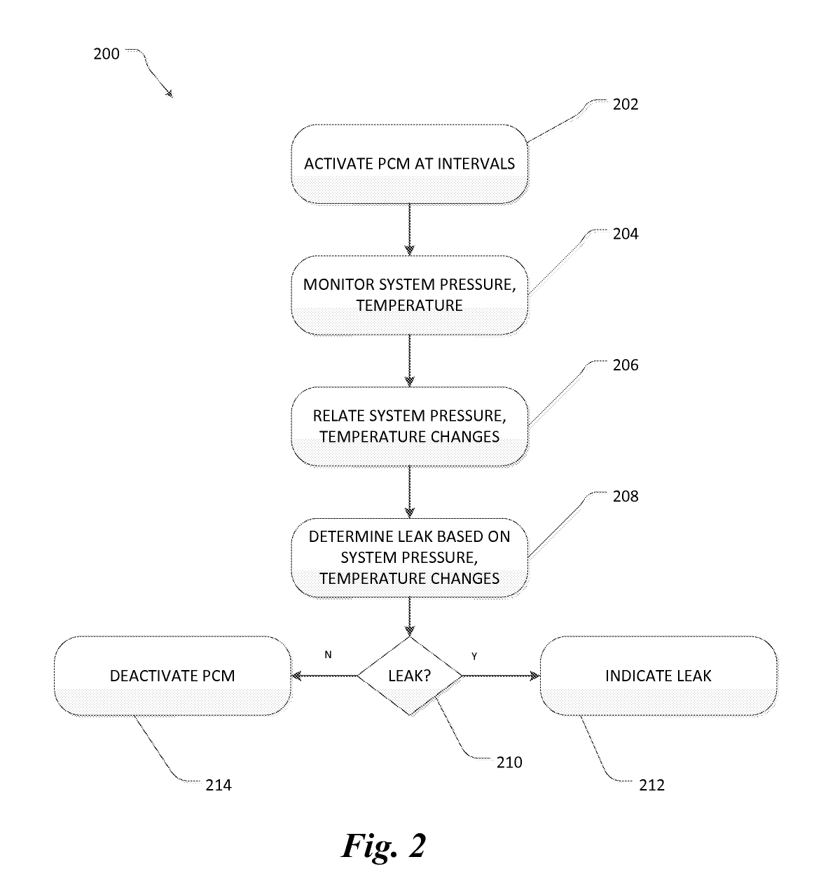

FIG. 2 is a flowchart setting out an inferential method 200 for EVAP system leak detection, in accordance with the present disclosure. The method begins at step 202 by activating the PCM 122. This activation takes place at scheduled intervals, preferably when the vehicle is in a key-off state. During a period when the vehicle is turned off for a number of hours, no danger exists that measurements might be skewed by fuel sloshing, refueling operations, or even the consumption of gasoline by running the engine. Instead, a period of relative quiescence provides an optimal opportunity to obtain valid monitoring results. The interval at which the PCM is activated can be selected and set, either during vehicle manufacturer, dealer preparation, or by a service technician. Typically, an interval of one or two hours may be found preferable.

While PCM 122 is active, it monitors system pressure and temperature (step 204), as reported by FTPT 106 and temperature sensor 101. In the illustrated embodiment, the leakage test of the present disclosure addresses the fuel tank 102 and associated components up to but not beyond FTIV 118. This portion of the EVAP system presents the highest risk of leakage, and is considered adequate to test in this location only. Some embodiments can add the canister 101 and associated fluid flow lines, requiring PCM to open FTIV 118. Additionally, this embodiment will require some equilibration time to allow any pressure differential between the interior of fuel tank 102 and the remainder of the EVAP system to equalize and stabilize.

PCM 122 then perform step 206, where it analyzes the pressure and temperature readings obtained in step 204, together with any past pressure and temperature readings obtained during the current series of intervals. Starting at least with a second reading, the system will have information showing changes of both temperature and pressure. Using the ideal gas law, PCM 122 can employ the change in temperature to calculate an expected pressure, assuming that no leak exists. That calculation can then proceed to determine a pressure offset, as the difference between expected and actual system pressure.

Step 208 compares the predicted pressure value with the actual pressure value to determine whether a leak can be inferred from the data. If no leak exists, step 210, a very close correlation should exist between the expected and actual pressure values. A difference between expected and actual values indicates that a leak may be present, provided that the actual pressure lies below the expected pressure. Those of skill in the art will be capable of refining this calculation to take into account specific factors that may come into play in specific situations. For example, fuel vapors within vapor dome 103 may behave in ways that depart from the ideal gas law in some respects. Routine experimentation can identify those factors, and the analytical algorithm can be modified accordingly. Other refinements will be clearly apparent to those in the art. To achieve a maximum degree of certainty, the system could activate a check routine upon identifying a possible leak. Such a routine could look to the time (readily available on the automobile's control system and compare that time to the normal hour at which the automobile was put in service. If several hours remain until a normal startup time, a decision on the presence of a leak could be put off by several hours in order to perform additional testing to confirm the result. These and other modifications will suggest themselves to those of skill in the art.

In some embodiments, PCM 122 can also include data, in a lookup table or other suitable format, showing experimental results of results obtained with leaks of specified sizes. Such data can be obtained using a reference orifice of the desired size, and the results can be assembled in tabular form. In that manner, the system can not only compare pressure value with the predicted pressure value, but a second comparison can be made with the expected result at various leak sizes. That result should provide increased accuracy in identifying leaks.

If no leak is inferred, the system deactivates PCM 122 and commences another interval, at step 214. On the other hand, if a leak is identified, at step 212, then the system indicates that fact. The indication can take a number of forms, such as a “need maintenance” message displayed to the user, or some other warning, either auditory or visual. In some embodiments, the nature of the warning could be tied to the severity of the leak identified. The severity factor can be inferred from the gap between predicted and actual pressure values, as would be clear to those in the art. Other circumstances can be anticipated and provided for with appropriate programming of PCM 122.

The system 100 may be applied to a variety of other applications as well. For example, any similar application, requiring the adherence to stringent emission regulations may make use of the disclosed subject matter. Accordingly, it may be well understood by those in the art that the description of the present disclosure is applicable to a variety of other environments as well, and thus, the environment disclosed here must be viewed as being purely exemplary in nature.

Further, the system 100 discussed so far is not limited to the disclosed embodiments alone, as those skilled in the art may ascertain multiple embodiments, variations, and alterations, to what has been described. Accordingly, none of the embodiments disclosed herein need to be viewed as being strictly restricted to the structure, configuration, and arrangement alone. Moreover, certain components described in the application may function independently of each other as well, and thus none of the implementations needs to be seen as limiting in any way.

Accordingly, those skilled in the art will understand that variations in these embodiments will naturally occur in the course of embodying the subject matter of the disclosure in specific implementations and environments. It will further be understood that such variations will fall within the scope of the disclosure. Neither those possible variations nor the specific examples disclosed above are set out to limit the scope of the disclosure. Rather, the scope of claimed subject matter is defined solely by the claims set out below.

We claim:

1. A method for detecting leaks in an evaporative emission control system, comprising activating a PCM at a selected interval, for a selected period;
monitoring system pressure and temperature during the period;
determining a relationship between changes in system temperature and changes in system pressure; and
inferring a leak occurs when such relationship satisfies criteria related to the relationship.

2. The method of claim 1, wherein determining includes calculating an expected system pressure based on any change in system temperature;
comparing the expected pressure to the currently monitored pressure to identify a pressure offset.

3. The method of claim 2, wherein the predetermined criteria includes a difference between the expected pressure and the currently monitored pressure exceeding a predetermined amount, the actual pressure being lower than the expected pressure.

4. The method of claim 3, further comprising modifying the calculation of an expected system pressure by incorporating additional experimentally determined factors related to the evaporative emission control system and the materials contained in that system.

5. The method of claim 1, wherein the relationship between changes in system temperature and changes in system pressure is governed by the ideal gas law, PV=nRT
where P is pressure,
V is volume,
n is the number of moles of gas,
R is the universal gas constant,
T is temperature.

6. The method of claim 1, wherein the selected period occurs at a time when the vehicle is in a key-off state.

7. An evaporative emission leak detection system, comprising a PCM for activating selected components, at a selected interval, for a selected period;
a sensor for monitoring system pressure and temperature during the period;
the PCM being configured to
determine a relationship between changes in system temperature and changes in system pressure; and
infer a leak upon the relationship satisfying predetermined criteria.

8. The method of claim 7, wherein determining includes calculating an expected system pressure based on any change in system temperature;
comparing the expected pressure to the currently monitored pressure to identify a pressure offset.

9. The method of claim 8, wherein the predetermined criteria includes a difference between the expected pressure and the currently monitored pressure exceeding a predetermined amount, the actual pressure being lower than the expected pressure.

10. The method of claim 9, further comprising modifying the calculation of an expected system pressure by incorporating additional experimentally determined factors related to the evaporative emission leak detection system and materials contained in that system.

11. The method of claim 7, wherein the relationship between changes in system temperature and changes in system pressure is governed by the ideal gas law, PV=nRT
where P is pressure,
V is volume,
n is the number of moles of gas,
R is the universal gas constant,
T is temperature.

12. The method of claim 7, wherein the selected period occurs at a time when the vehicle is in a key-off state.
